(19) United States
(12) Patent Application Publication
(10) Pub. No.: US 2004/0212809 A1
(43) Pub. Date: Oct. 28, 2004

(54) Beam delivery methods, and systems, and wafer edge exposure apparatus delivering a plurality of laser beams

(76) Inventors: Woo-Seok Shim, Seoul (KR); Gi-Sung Yeo, Seoul (KR); Jung-Hyeon Lee, Gyeonggi-do (KR); Sung-Woo Lee, Gyeonggi-do (KR)

Correspondence Address: Laura M. Kelley, Myers Bigel Sibley & Sajovec, P.A., P. O. Box 37428, Raleigh, NC, 27627, US

(21) Appl. No.: 10/819,363

(22) Filed: Apr. 6, 2004

(30) Foreign Application Priority Data
Apr. 22, 2003 (KR) 2003-25307

(51) Int. Cl. G01B 9/02

(52) U.S. Cl. 356/479

(57) ABSTRACT

Methods for delivering a beam in a wafer edge exposure process include (a) generating a laser beam; (b) dividing the laser beam into a plurality of wafer processing laser beams; and (c) delivering ones of the plurality of wafer processing laser beams onto edge portions of a plurality of wafers.

### RELATED APPLICATION

The present application claims priority from Korean Patent Application No. 2003-25307, filed Apr. 22, 2003, the disclosure of which is incorporated herein by reference in its entirety.

### FIELD OF THE INVENTION

The present invention relates to wafer fabrication, and more particularly to methods and systems for delivering a laser beam in a wafer edge exposure process.

### DESCRIPTION OF THE RELATED ART

Generally, semiconductor devices are manufactured through a three-step process. In the first step, a fabrication process is performed for forming electronic circuits on a wafer, such as a silicon wafer, that is used as a semiconductor substrate. In the second step, an electrical die sorting (EDS) process is performed for inspecting the electrical characteristics of the semiconductor devices on the semiconductor substrate. In the third step, a packaging process is performed for separating the semiconductor devices and packaging the semiconductor devices in epoxy resins.

The fabrication process may include a deposition process(es) for depositing a layer(s) on the semiconductor substrate, a chemical mechanical polishing (CMP) process(es) for planarizing a surface of a layer(s), a photolithography process(es) for forming a photoresist pattern on a layer(s), an etching process(es) for forming an electrical pattern(s) using the photoresist pattern(s), an ion implantation process(es) for implanting predetermined ions into predetermined portions of the semiconductor substrate, a cleaning process(es) for removing impurities from the semiconductor substrate, an inspection process(es) for inspecting defects on the semiconductor substrate on which the layer(s) or the pattern(s) is formed, and/or other processes.

A photolithography process may include coating the wafer with a photoresist composition, soft baking the coated photoresist composition on the wafer into a photoresist layer, an edge bead removal process and/or removing a portion of the photoresist layer on the edge portion of the wafer, exposing developing the photoresist layer into a photoresist pattern, hardening the photoresist pattern on the wafer, and/or other processes.

A wafer edge exposure process can be performed to remove a portion of the photoresist layer from the edge portion of the wafer. A light source such as a mercury lamp or a sodium lamp may be used in a conventional edge exposure process. FIG. 1 is a cross-sectional view of a conventional wafer edge exposure apparatus.

Referring to FIG. 1, in a conventional wafer edge exposure apparatus 100, a chuck 120 for supporting a wafer W is disposed in an exposure chamber 110. A driving section 130 for rotating the chuck 120 is connected to a lower portion of the chuck 120 through a driving shaft 132. A mercury lamp 140 for irradiating a light onto an edge portion of the wafer W, which is supported on the chuck 120, is disposed over the edge portion of the wafer W.

The light generated from the mercury lamp 140 is irradiated onto the edge portion of the wafer W through a slit-plate 142. The wafer W is supported on the chuck 120, which rotates due to the driving force applied from the driving section 130. Light transmitted through the slit-plate 142 scans the edge portion of the wafer W.

Although not shown in FIG. 1, the conventional edge exposure apparatus 100 may also include a second driving section for moving the mercury lamp 140 and the slit-plate 142 so that the light transmitted through the slit-plate may scan a flat zone portion of the wafer W.

The light generated from the mercury lamp 140 includes light having various wavelengths. Specific wavelengths of light may be desired to change a property of the photoresist layer on the wafer W. However, the intensity of light at the desired wavelength may be relatively lower than the intensity of other wavelengths of light produced by the mercury lamp 140. Thus, the time required to sufficiently change the property of the photoresist layer by exposing the wafer W to the light may be increased, and the throughput of the edge exposure apparatus 100 may be reduced.

Moreover, if the property of the photoresist layer is not sufficiently changed, a photoresist residue may remain on the edge portion of the wafer W after subsequent development processes. The photoresist residue may cause failures in the subsequent processes and may reduce the performance characteristics of semiconductor devices formed on the wafer.

### SUMMARY OF THE INVENTION

According to embodiments of the present invention, methods for delivering a beam in a wafer edge exposure process include (a) generating a laser beam; (b) dividing the laser beam into a plurality of wafer processing laser beams; and (c) delivering ones of the plurality of wafer processing laser beams onto edge portions of a plurality of wafers.

In certain embodiments, the plurality of wafer processing laser beams have substantially the same intensity. In particular embodiments, the dividing step (b) includes: (d) dividing the laser beam into one of the plurality of wafer processing laser beams and a remainder laser beam; and (e) dividing the remainder laser beam into another one of the plurality of wafer processing laser beams and a subsequent remainder laser beam. In some embodiments, the dividing step (b) includes (f) repeatedly performing step (e) on subsequent remainder laser beams to provide the plurality of wafer processing beams. In particular embodiments, step (f) includes dividing a final remainder laser beam into two of the plurality of wafer processing laser beams. Each of the plurality of wafer processing laser beams can be focused onto an optical fiber of a beam delivery member.

In certain embodiments, the dividing step (b) may include providing a series of beam splitters, each of the series of beam splitters reflecting a portion of the laser beam to provide ones of the plurality of wafer processing laser beams and transmitting a remaining portion of the laser beam to provide a remainder laser beam to a subsequent beam splitter in the series of beam splitters. A transmission/reflectance ratio may be selected for each of the beam splitters in the series of beam splitters so that each of the reflected portions of the laser beams are substantially the same intensity. The laser beam, for example, can be an XeF excimer laser beam, an XeCl excimer laser beam, a KrF excimer laser beam, an ArF excimer laser beam or a F2 excimer laser beam.

In certain embodiments, laser beam is a first laser beam and the dividing step (b) includes dividing the first laser beam into a first wafer processing laser beam and a second laser beam; dividing the second laser beam into a second wafer processing laser beam and a third laser beam; dividing an (N−1)th laser beam into an (N−1)th wafer processing laser beam and an (N)th laser beam, where N is an integer greater than 1; and dividing the (N)th laser beam into an (N)th wafer processing laser beam and an (N+1)th laser beam. The (N)th wafer processing laser beam and the (N+1)th laser beam may have substantially the same intensity.

According to further embodiments of the present invention, systems for delivering a beam used in a wafer edge exposure process include a laser for generating a laser beam. A beam-dividing unit can be configured to receive the laser beam and to divide the laser beam into a plurality of wafer processing laser beams. A plurality of beam delivery members can be configured to receive respective ones of the wafer processing laser beams and to deliver the wafer processing laser beams to a plurality of wafer edge exposure units for performing edge exposure processes on a plurality of wafers. In some embodiments, the plurality of wafer processing laser beams can have substantially the same intensity.

In certain embodiments, the beam-dividing unit includes a plurality of beam splitters disposed in series on a path of the laser beam, each of the plurality of beam splitters reflecting a reflected portion of the laser beam so as to form one of the plurality of wafer processing laser beams, and transmitting a remainder portion of the laser beam.

In particular embodiments, the beam delivery members can include a plurality of optical fibers. The beam-dividing unit can further include a housing disposed on the path of the laser beam configured to receive the plurality of beam splitters, and the housing can be connected to the optical fibers and can have an opening through which the laser beam is passed. The beam-dividing unit can further include a plurality of focusing lenses configured to focus the wafer processing laser beams onto respective end portions of the optical fibers.

In certain embodiments, the beam-dividing unit includes N splitters disposed in series on the path of the laser beam, where N is an integer greater than 1. A first splitter can reflect a portion of the laser beam to form a first wafer processing laser beam and can transmit a portion of the remaining laser beam to form a second laser beam. A second splitter can reflect a portion of the second laser beam to form a second wafer processing laser beam and can transmit a portion of the remaining second laser beam to form a third laser beam and so forth so that an (N−1)th splitter reflects a portion of the (N−1)th laser beam to form an (N−1)th wafer processing laser beam and transmits a portion of the remaining (N−1)th laser beam to form an (N)th laser beam, and an (N)th splitter reflects a portion of the (N)th laser beam to form an (N)th wafer processing laser beam and transmits a portion of the remaining (N)th laser beam to form an (N+1)th laser beam. The (N)th divided laser beam and the (N+1)th laser beam can have substantially the same intensity.

The laser beam can be an XeF excimer laser beam, an XeCl excimer laser beam, a KrF excimer laser beam, an ArF excimer laser beam or a F2 excimer laser beam.

In some embodiments, an apparatus for exposing an edge portion of a wafer includes a plurality of edge exposure units for performing edge exposure processes on a plurality of wafers and a beam delivery system connected to the edge exposure units. The beam delivery system can include a laser for generating a laser beam. A beam-dividing unit can be configured to receive the laser beam and to divide the laser beam into a plurality of wafer processing laser beams. A plurality of beam delivery members can be configured to receive respective ones of the wafer processing laser beams and to deliver the wafer processing laser beams to a plurality of wafer edge exposure units configured to perform edge exposure processes on a plurality of wafers. The beam-dividing unit can include features described above.

In certain embodiments, each edge exposure unit includes a chuck configured to support a wafer. A beam irradiation section can be connected to one of the beam delivery members and configured to irradiate one of the wafer processing laser beams onto an edge portion of the wafer supported on the chuck. A first driving section can be connected to the chuck and configured to rotate the chuck so that the wafer processing laser beam irradiated from the beam irradiation section scans a circumferential edge portion of the wafer. A second driving section can be connected to the beam irradiation section and configured to move the beam irradiation section so that the wafer processing laser beam irradiated from the beam irradiation section scans a straight edge portion corresponding to a flat zone of the wafer.

In particular embodiments, the second driving section includes a Cartesian coordinate robot configured to move the beam irradiation section and a robot arm configured to connect the beam irradiation section with the Cartesian coordinate robot.

### BRIEF DESCRIPTION OF THE DRAWINGS

FIG. 1 is a cross-sectional view illustrating a conventional wafer edge exposure apparatus.

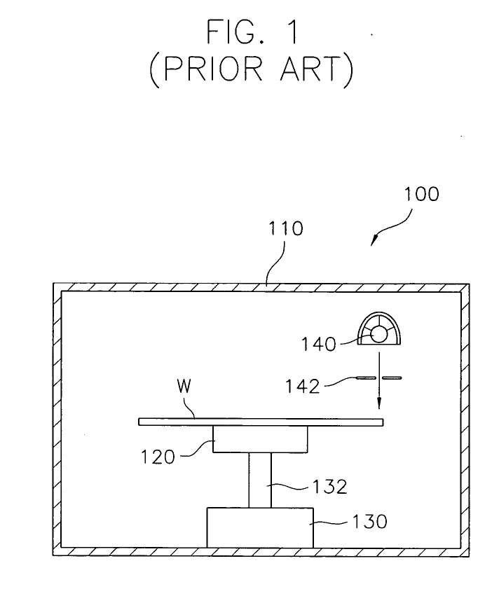

FIG. 2 is a schematic view illustrating a beam delivery system according to embodiments of the present invention.

FIG. 3 is a schematic view illustrating a beam delivery system according to other embodiments of the present invention.

FIG. 4 is a cross-sectional view illustrating a wafer edge exposure unit as shown in FIG. 2.

FIG. 5 is a perspective view illustrating the wafer edge exposure unit as shown in FIG. 4.

### DETAILED DESCRIPTION

The present invention will now be described more fully hereinafter with reference to the accompanying drawings, in which embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. As used herein, “connect” means that the referenced elements are either directly or indirectly connected, i.e., that the referenced elements may be attached either to each other or by way of one or more common intermediate elements. Like numbers refer to like elements throughout the specification.

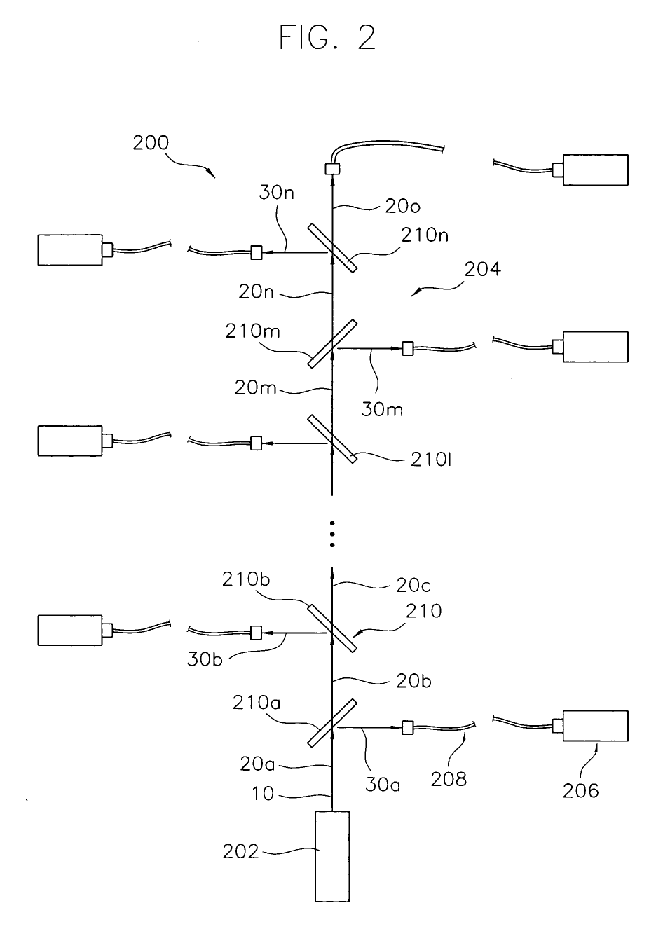

FIG. 2 is a schematic view illustrating a beam delivery system according to first embodiments of the present invention.

Referring to FIG. 2, a beam delivery system 200 according to first embodiments of the present invention may include a laser 202 for generating a laser beam, a beam-dividing unit 204 for dividing the laser beam into a plurality of wafer processing laser beams having substantially the same intensity, and a plurality of beam delivery members 208 for delivering the wafer processing laser beams to a plurality of wafer edge exposure units 206 for performing edge exposure processes on a plurality of wafers.

Examples of the laser 202 may include an XeF excimer laser, an XeCl excimer laser, a KrF excimer laser, an ArF excimer laser, a F₂ excimer laser, or the like. A wavelength of the laser beam may be selected in accordance with a property of the photoresist layer that is formed on each wafer. An XeF excimer laser beam, for example, has a wavelength of about 351 nm, an XeCl excimer laser beam has a wavelength of about 308 nm, a KrF excimer laser beam has a wavelength of about 248 nm, an ArF excimer laser beam has a wavelength of about 193 nm, and a F₂ excimer laser beam has a wavelength of about 157 nm.

For example, the laser beam may be selectively used for the exposure process in accordance with the desired size of the photoresist pattern. For example, the KrF excimer laser beam has a wavelength of about 248 nm and may be used for the exposure process when the photoresist pattern has a critical dimension (CD) in the range of about 0.13 mm to about 0.25 mm. The ArF excimer laser beam has a wavelength in the range of about 193 nm and may be used for the exposure process when the photoresist pattern has a CD in the range of of about 0.07 mm to about 0.15 mm. The F₂ excimer laser beam has a wavelength of about 157 nm and may be used for the exposure process when the photoresist pattern has a CD smaller than about 0.1 mm.

The beam-dividing unit 204 includes a plurality of splitters 210a-n disposed in a path 10 of the laser beam in series so as to sequentially divide the laser beam generated from the laser 202. The beam-dividing unit 204 can provide a plurality of wafer processing laser beams to the plurality of wafer edge exposure units 206 for performing edge exposure processes on a plurality of wafers.

The splitters 210a-n can reflect a portion of the laser beam generated from the laser 202 and transmit another portion of the laser beam so as to form the wafer processing laser beams 30a-n. As illustrated in FIG. 2, each of the splitters 210a-n receives a laser beam and divides it into one of the plurality of wafer processing laser beams and a remainder laser beam. The resulting remainder laser beam is then divided by a subsequent one of the splitters 210a-n into another one of the plurality of wafer processing laser beams and a subsequent remainder laser beam. This process can be repeated to provide the plurality of wafer processing laser beams. In certain embodiments, the plurality of wafer processing laser beams have substantially the same intensity.

In particular, the beam-dividing unit 204 includes N splitters 210a-n, where N is an integer greater than 1. A splitter 210a divides a laser beam 20a into a beam processing laser beam 30a and a remainder laser beam 20b. Another splitter 210b divides the remainder laser beam 20b into another beam processing laser beam 30b and a subsequent remainder beam 20c. An (N−1)th splitter 210m divides an (N−1)th remainder laser beam 20m into an (N−1)th wafer processing laser beam 30m and an (N)th remainder laser beam 20n. An (N)th splitter 210n divides the (N)th remainder laser beam 20n into an (N)th wafer processing beam laser beam 30n and an (N+1)th remainder laser beam 20o. As illustrated in FIG. 2, the (N+1)th remainder laser beam 20o has substantially the same intensity as the plurality of wafer processing beams 30a-n, and therefore, the remainder laser beam 20o can also be provided as a wafer processing beam to one of the wafer edge exposure units 206 for performing edge exposure processes on a plurality of wafers. In other words, the last beam splitter 210n can split the laser beam 20n into two wafer processing laser beams: wafer processing beam 30n and remainder laser beam 20o. The (N)th divided laser beam 30n and the (N+1)th laser beam 20o may have substantially the same intensity.

As illustrated in FIG. 2, the first splitter 210a reflects a portion of the laser beam 20a and transmits the remaining portion of the laser beam 20a. The second splitter 210b reflects a portion of the second laser beam 20b, and transmits the remaining portion of the second laser beam 20b and so forth. The (N−1)th splitter 210m reflects a portion of the (N−1)th laser beam 20m, and transmits the remaining portion of the remaining (N−1)th laser beam. The (N)th splitter 210n reflects a portion of the (N)th laser beam 20n, and transmits the remaining portion of the (N)th laser beam.

In some embodiments, the ratios of the intensities of the reflected laser beams (i.e., the wafer processing laser beams) from the splitters 210a-n and the transmitted laser beams (i.e., the remainder laser beams) through the splitters 210a-n can be selected so that each of the reflected laser beams have substantially the same intensity. For example, the ratio of the reflected beam intensity and the transmitted beam intensity can be gradually decreased. As a particular example, if the ratio of the intensities between the first wafer processing laser beam 30a and the second wafer processing beam 20b is 1:9, the ratio of the intensities between the second wafer processing laser beam 30b and the third wafer processing laser beam 20c can be 1:8. A ratio of the intensities of the (N−1)th divided laser beam 30m and the (N)th laser beam 20n can be 1:2, and the ratio of the intensities between the (N)the divided laser beam 30n and the (N+1)th laser beam 20o can be 1:1. Accordingly, the beam-dividing unit 204 having the N splitters divides the first laser beam 20a into the N+1 wafer processing laser beams. In this example, N may equal 9 so that 9 splitters are included in the beam-dividing unit 204 and so that 10 wafer edge exposure units 206 are supported.

The beam delivery members 208 may each be connected to the wafer edge exposure units 206. The wafer processing laser beams are delivered into the edge exposure units 206. Each beam delivery member 208 may include an optical fiber or fiber bundle, and may also include various optical components, the selection of which may be determined by one of ordinary skill in the art.

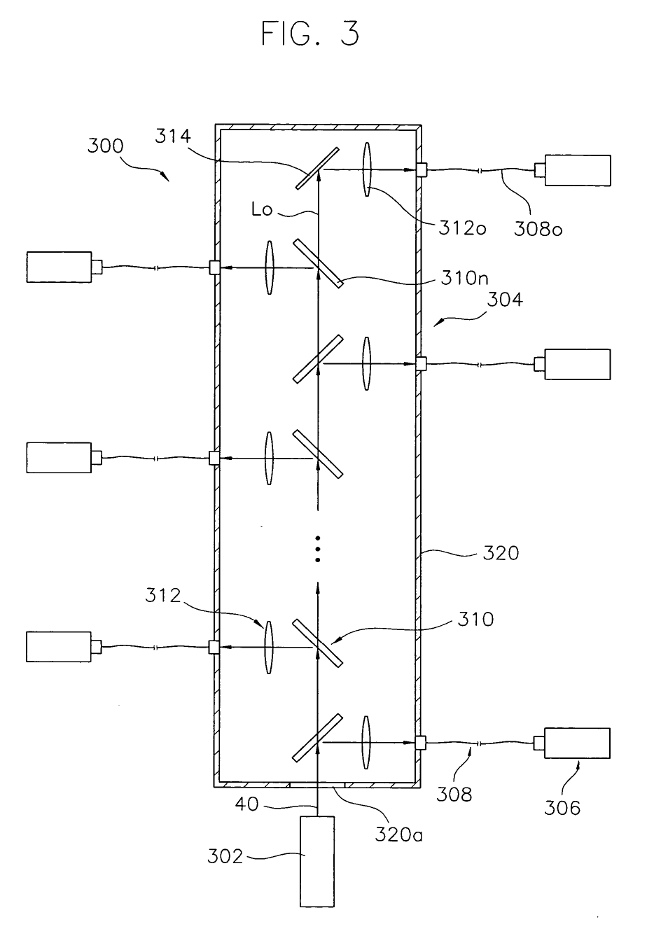

FIG. 3 is a schematic view illustrating a beam delivery system according to further embodiments of the present invention.

Referring to FIG. 3, a beam delivery system 300 according to further embodiments of the present invention may include a laser 302 for generating a laser beam, a beam-dividing unit 304 for forming the laser beam into a plurality of wafer processing laser beams having substantially the same intensity, and a plurality of beam delivery members 308 for delivering the wafer processing laser beams to a plurality of wafer edge exposure units 306 for performing edge exposure processes on a plurality of wafers.

The beam-dividing unit 304 may include a housing 320 disposed in a path 40 of the laser beam generated from the laser 302, a plurality of splitters 310 disposed in the housing 320, and a plurality of focusing lenses 312.

The splitters 310 and the focusing lenses 312 are disposed in the housing 320. The housing 320 has an opening 320a through which the laser beam generated from the laser 302 is transmitted. The splitters 310 are disposed in series on the path 40 of the laser beam. The beam delivery members 308 are connected to both sidewalls of the housing 320.

The wafer processing laser beams reflected by the splitters 310 are focused onto end portions of the beam delivery members 308 by the focusing lenses 312, respectively.

When N splitters 310 are disposed in the housing 320, where N is an integer greater than 1, N+1 focusing lenses 312 can be disposed in the housing 320, and N+1 beam delivery members 308 may be connected to the housing 320. As illustrated, an (N+1)th focusing lens 312o focuses an (N+1)th laser beam Lo transmitted through an (N)th splitter 310n onto an end portion of an (N+1)th beam delivery member 308o. Further, a reflecting mirror 314 for reflecting the (N+1)th laser beam Lo to the (N+1)th focusing lens 312o is disposed in the housing 320.

Further detailed descriptions of these elements will be omitted because these elements are similar to those already described in connection with the beam delivery system 200 as shown in FIG. 2.

A wafer edge exposure apparatus may include a beam delivery system, such as the beam delivery system 200 or 300 as shown in FIG. 2 or FIG. 3, and a plurality of wafer edge exposure units, such as the plurality of wafer edge exposure units 206 or 306 as shown in FIG. 2 or FIG. 3.

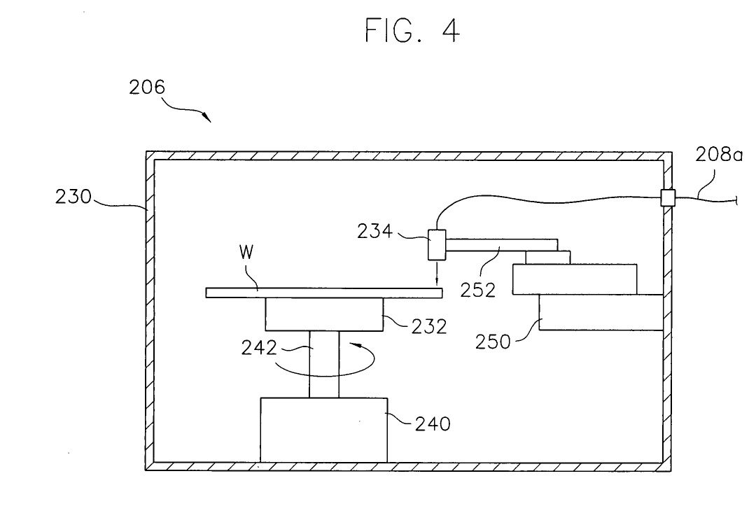

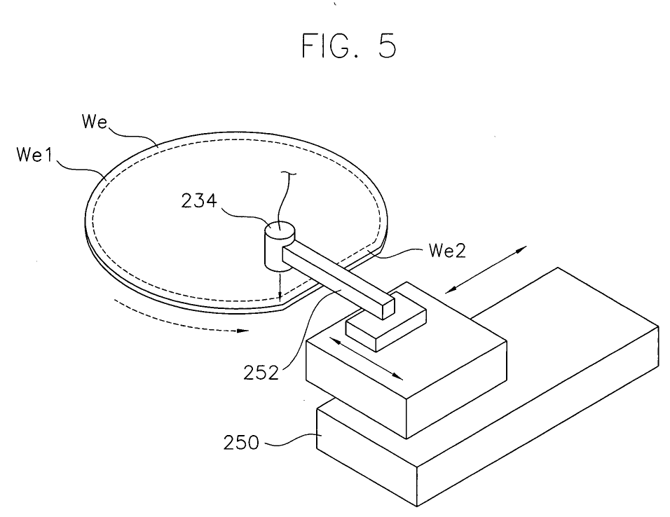

FIG. 4 is a cross-sectional view illustrating a wafer edge exposure unit as shown in FIG. 2, and FIG. 5 is a perspective view illustrating the wafer edge exposure unit as shown in FIG. 4.

Referring to FIGS. 4 and 5, the wafer edge exposure unit 206 may include an exposure chamber 230 for performing the wafer edge exposure process and a plurality of elements disposed in the exposure chamber 230.

A chuck 232 configured to support a wafer W, a beam irradiation section 234, a first driving section 240 configured to rotate the chuck 232 and a second driving section 250 configured to move the beam irradiation section 234 may be disposed in the exposure chamber 230. The beam irradiation section 234 is connected to a beam deliver member 208a, which can be one of the beam delivery members 208 shown in FIG. 2, and irradiates one of the wafer processing laser beams onto an edge portion We of the wafer W (FIG. 5).

The first driving section 240 is disposed on a bottom surface of the exposure chamber 230, and is connected to a lower portion of the chuck 232 through a driving shaft 242. The first driving section 240 rotates the chuck 232 so that the wafer processing laser beam irradiated from the beam irradiation section 234 scans the circumferential edge portion We1 of the wafer W.

The second driving section 250 is mounted on an inner surface of a sidewall of the exposure chamber 230, and is connected with the beam irradiation section 234. The second driving section 250 moves the beam irradiation section 234 so that the wafer processing laser beam irradiated from the beam irradiation section 234 scans a straight edge portion We2 corresponding to a flat zone of the wafer W. An example of the second driving section 250 may include a Cartesian coordinate robot. The Cartesian coordinate robot may be connected to the beam irradiation section 234 through a robot arm 252.

According to embodiments of the present invention, the beam delivery system can deliver the wafer processing laser beams into the wafer edge exposure units. The wafer processing laser beams can have a wavelength and sufficient intensity to change a desired property of the photoresist layer on the wafer.

Thus, the time required for the wafer edge exposure process may be reduced, and throughput of the wafer edge exposure apparatus may be increased. Furthermore, the process efficiency may be increased by using the plurality of divided laser beams in the edge exposure processes.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A method for delivering a beam in a wafer edge exposure process, comprising:
(a) generating a laser beam;
(b) dividing the laser beam into a plurality of wafer processing laser beams; and
(c) delivering ones of the plurality of wafer processing laser beams onto edge portions of a plurality of wafers.

2. The method of claim 1, wherein the plurality of wafer processing laser beams have substantially the same intensity.

3. The method of claim 1, wherein the dividing step (b) includes:
(d) dividing the laser beam into one of the plurality of wafer processing laser beams and a remainder laser beam; and
(e) dividing the remainder laser beam into another one of the plurality of wafer processing laser beams and a subsequent remainder laser beam.

4. The method of claim 3, wherein the dividing step (b) further includes:
(f) repeatedly performing step (e) on subsequent remainder laser beams to provide the plurality of wafer processing beams.

5. The method of claim 4, wherein step (f) includes dividing a final remainder laser beam into two of the plurality of wafer processing laser beams.

6. The method of claim 1, further comprising focusing each of the plurality of wafer processing laser beams onto a respective optical fiber of a beam delivery member.

7. The method of claim 1, wherein the dividing step (b) includes providing a series of beam splitters, each of the series of beam splitters reflecting a portion of the laser beam to provide ones of the plurality of wafer processing laser beams and transmitting a remaining portion of the laser beam to provide a remainder laser beam to a subsequent beam splitter in the series of beam splitters.

8. The method of claim 7, further comprising selecting a transmission/reflectance ratio for each of the beam splitters in the series of beam splitters so that each of the reflected portions of the laser beams have substantially the same intensity.

9. The method of claim 1, wherein the laser beam comprises an XeF excimer laser beam, an XeCl excimer laser beam, a KrF excimer laser beam, an ArF excimer laser beam or a F2 excimer laser beam.

10. The method of claim 1, wherein the laser beam is a first laser beam and the dividing step (b) includes:
dividing the first laser beam into a first wafer processing laser beam and a second laser beam;
dividing the second laser beam into a second wafer processing laser beam and a third laser beam;
dividing an (N−1)th laser beam into an (N−1)th wafer processing laser beam and an (N)th laser beam, where N is an integer greater than 1; and
dividing the (N)th laser beam into an (N)th wafer processing laser beam and an (N+1)th laser beam.

11. The method of claim 10, wherein the (N)th wafer processing laser beam and the (N+1)th laser beam have substantially the same intensity.

12. A system for delivering a beam used in a wafer edge exposure process, comprising:
a laser for generating a laser beam;
a beam-dividing unit configured to receive the laser beam and to divide the laser beam into a plurality of wafer processing laser beams; and
a plurality of beam delivery members configured to receive respective ones of the wafer processing laser beams and to deliver the wafer processing laser beams to a plurality of wafer edge exposure units configured to perform edge exposure processes on a plurality of wafers.

13. The system of claim 12, wherein the plurality of wafer processing laser beams have substantially the same intensity.

14. The system of claim 12, wherein the beam-dividing unit includes a plurality of beam splitters disposed in series on a path of the laser beam, each of the plurality of beam splitters reflecting a reflected portion of the laser beam so as to form one of the plurality of wafer processing laser beams, and transmitting a remainder portion of the laser beam.

15. The system of claim 12, wherein the beam delivery members include a plurality of optical fibers.

16. The system of claim 15, wherein the beam-dividing unit further includes a housing disposed on the path of the laser beam configured to receive the plurality of beam splitters, wherein the housing is connected to the optical fibers and has an opening through which the laser beam is passed.

17. The system of claim 15, wherein the beam-dividing unit further includes a plurality of focusing lenses configured to focus the wafer processing laser beams onto respective end portions of the optical fibers.

18. The system of claim 12, wherein the beam-dividing unit includes N splitters disposed in series on the path of the laser beam, where N is an integer greater than 1, wherein a first splitter reflects a portion of the laser beam to form a first wafer processing laser beam and transmits a portion of the remaining laser beam to form a second laser beam, a second splitter reflects a portion of the second laser beam to form a second wafer processing laser beam and transmits a portion of the remaining second laser beam to form a third laser beam and so forth so that an (N−1)th splitter reflects a portion of the (N−1)th laser beam to form an (N−1)th wafer processing laser beam and transmits a portion of the remaining (N−1)th laser beam to form an (N)th laser beam, and an (N)th splitter reflects a portion of the (N)th laser beam to form an (N)th wafer processing laser beam and transmits a portion of the remaining (N)th laser beam to form an (N+1)th laser beam.

19. The system of claim 18, wherein the (N)th divided laser beam and the (N+1)th laser beam have substantially the same intensity.

20. The system of claim 12, wherein the laser beam comprises an XeF excimer laser beam, an XeCl excimer laser beam, a KrF excimer laser beam, an ArF excimer laser beam or a F₂ excimer laser beam.

21. An apparatus for exposing an edge portion of a wafer, the apparatus comprising:
a plurality of edge exposure units configured to perform edge exposure processes on a plurality of wafers; and
a beam delivery system connected to the edge exposure units,
wherein the beam delivery system includes:
a laser for generating a laser beam;
a beam-dividing unit configured to divide the laser beam into a plurality of wafer processing laser beams; and
a plurality of beam delivery members configured to deliver the plurality of wafer processing laser beams to the edge exposure units, the edge exposure units configured to perform the wafer edge exposure processes on each of edge portions of the wafers.

22. The apparatus of claim 21, wherein the plurality of wafer processing laser beams have substantially the same intensity.

23. The apparatus of claim 21, wherein the beam-dividing unit includes a plurality of beam splitters disposed in series on a path of the laser beam, each of the plurality of beam splitters reflecting a reflected portion of the laser beam so as to form one of the plurality of wafer processing laser beams, and transmitting a remainder portion of the laser beam.

24. The apparatus of claim 21, wherein each edge exposure unit includes:
a chuck configured to support a wafer;
a beam irradiation section connected to one of the beam delivery members, wherein the beam irradiation section is configured to irradiate one of the wafer processing laser beams onto an edge portion of the wafer supported on the chuck;
a first driving section connected to the chuck and configured to rotate the chuck so that the wafer processing laser beam irradiated from the beam irradiation section scans a circumferential edge portion of the wafer; and
a second driving section connected to the beam irradiation section and configured to move the beam irradiation section so that the wafer processing laser beam irradiated from the beam irradiation section scans a straight edge portion corresponding to a flat zone of the wafer.

25. The apparatus of claim 24, wherein the second driving section includes a Cartesian coordinate robot configured to move the beam irradiation section and a robot arm configured to connect the beam irradiation section with the Cartesian coordinate robot.

26. The apparatus of claim 21, wherein the laser comprises an XeF excimer laser, an XeCl excimer laser, a KrF excimer laser, an ArF excimer laser or a F2 excimer laser.

27. The apparatus of claim 21, wherein the beam-dividing unit includes N splitters disposed in series on the path of the laser beam, where N is an integer greater than 1, wherein a first splitter reflects a portion of the laser beam to form a first wafer processing laser beam and transmits a portion of the remaining laser beam to form a second laser beam, a second splitter reflects a portion of the second laser beam to form a second wafer processing laser beam and transmits a portion of the remaining second laser beam to form a third laser beam and so forth so that an (N−1)th splitter reflects a portion of the (N−1)th laser beam to form an (N−1)th wafer processing laser beam and transmits a portion of the remaining (N−1)th laser beam to form an (N)th laser beam, and an (N)th splitter reflects a portion of the (N)th laser beam to form an (N)th wafer processing laser beam and transmits a portion of the remaining (N)th laser beam to form an (N+1)th laser beam.

28. The apparatus of claim 27, wherein the (N)th divided laser beam and the (N+1)th laser beam have substantially the same intensity
